(19) United States
(12) Patent Application Publication
(10) Pub. No.: US 2004/0099491 A1
(43) Pub. Date: May 27, 2004

(54) Electrically-applied transmission brake band

(76) Inventors: Paul D. Stevenson, Ann Arbor, MI (US); Jeffrey J. Biallas, Dexter, MI (US)

Correspondence Address: LESLIE C. HODGES, General Motors Corporation, Legal Staff, Mail Code 482-C23-B21, P.O. Box 300, Detroit, MI, 48265-3000, US

(21) Appl. No.: 10/303,243

(22) Filed: Nov. 25, 2002

(51) Int. Cl. F16D 51/00

(52) U.S. Cl. 188/77 W

(57) ABSTRACT

A brake band and apply mechanism includes a brake drum and a brake band surrounding the drum. The brake band is enforced into engagement and disengagement with the drum through an apply mechanism which includes a rotary electric motor and a linear output member. The linear output member is operatively connected with the brake band. A rotary-to-linear transfer or torque to thrust mechanism is disposed between the motor rotary output and the brake band linear input to enforce engagement and disengagement of the brake band. The motor power is only required during apply and release of the band.

### TECHNICAL FIELD

This invention relates to transmission brakes and, more particularly, to band-type transmission brakes.

### BACKGROUND OF THE INVENTION

Power transmissions employing planetary gearsets utilize two types of brakes. One type is a multi-disc friction-type hydraulically-applied mechanism and the other is a band mechanism, which is wrapped around a rotatable drum and grounded to a transmission housing. Both the disc-type and band-type brakes are applied hydraulically. Each of these types of devices has a servo apply system wherein hydraulic fluid pressure is supplied to a piston, which then transmits force to the brake elements.

In the case of the band-type brakes, the servomechanism usually incorporates a rod member, which engages one end of a brake band while the other end is secured or grounded through an anchor pin to a stationary housing within the transmission. By applying hydraulic fluid to the servomechanism, the band is caused to tighten around the drum to initiate engagement and to release from the drum to initiate disengagement.

The use of hydraulic apply mechanisms requires the use of a high pressure control pump and significant control valving as well as passages formed either in the transmission housing or in tubing which must be installed in the transmission housing. While these devices operate quite satisfactorily, the hydraulic portions are not as efficient as some might desire.

### SUMMARY OF THE INVENTION

It is an object of the present invention to provide an improved band brake apply mechanism.

In one aspect of the present invention, a torque to thrust mechanism is employed to actuate a brake band. In another aspect of the present invention, the torque to thrust mechanism provide a rotary to linear actuator.

In another aspect of the present invention, the torque to thrust mechanism includes an electric motor driving a rotatable member, which in turn actuates a linearly movable member connected with the brake band.

In yet another aspect of the present invention, the rotatable member secured with the electric motor is a screw-type member and the other portion is a follower member, which meshes with the screw portion.

In still another aspect of the present invention, a spiral spring is disposed between the electric motor output and the brake band input to convert the rotary motion of the electric motor to linear motion for the band apply mechanism.

In yet still another aspect of the present invention, a cam ramp and ball mechanism is disposed between the electric motor rotary input and the band engaging linear output.

In a further aspect of the present invention, the band apply mechanism is disposed to actuate both sides of a brake band system.

### DESCRIPTION OF THE DRAWINGS

FIG. 1 is a diagrammatic representation of a transmission brake band and apply mechanism incorporating the present invention.

FIG. 2 is an alternative embodiment of the apply mechanism incorporating the present invention.

FIG. 3 is another alternative embodiment of the apply mechanism incorporating the present invention.

FIG. 4 is a further embodiment of the apply mechanism incorporating the present invention.

FIG. 5 is yet another embodiment of the apply mechanism incorporating the present invention.

FIG. 6 is a diagrammatic and schematic representation of a brake band apply mechanism incorporating the present invention utilizing two half wrap bands.

FIG. 7 is a view similar to FIG. 6 describing another brake band system utilizing two half wrap bands.

FIG. 8 is yet another brake band mechanism incorporating the present invention utilizing two half wrap bands.

### DESCRIPTION OF THE EXEMPLARY EMBODIMENT

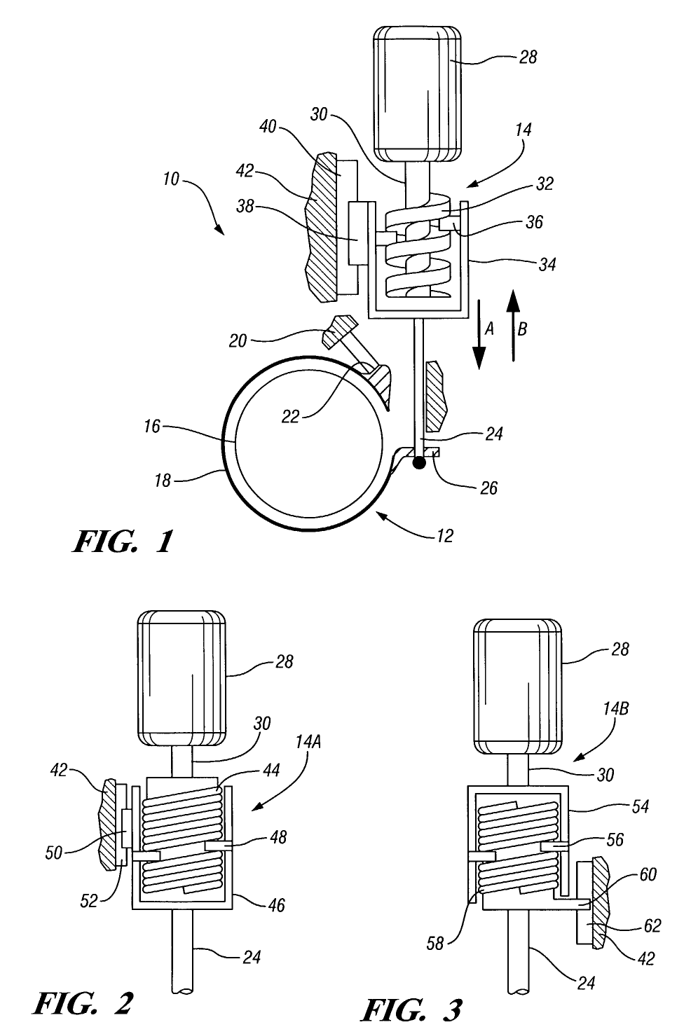

Referring to the drawings, wherein like characters represent the same or corresponding parts throughout the several views, there is seen in FIG. 1 a transmission brake system 10. The brake system 10 includes a band brake 12, a band brake apply system or mechanism 14, and a drum member 16. The drum member 16 is a conventional transmission member, which is generally connected with either a gear or a shaft that is desired to be held stationary during some portion of transmission operation.

The band brake 12 is a friction device, which includes a friction surface 18 on the inner side of the band brake 12 that is engageable with the outer surface of the drum 16. The band is anchored to a stationary transmission housing member 20 at a first end 22 and is operatively or drivingly connected with a rod 24 at an end 26 of the band brake 12. The rod 24 is a portion of the band brake apply mechanism 14.

The band brake apply mechanism 14 also includes a conventional electric motor 28, which is drivingly connected with a shaft 30 on which is formed a helical screw 32. Also included in the band brake apply mechanism 14 is a housing 34, which includes a follower 36 engaging between the threads of the screw 32. The screw 32 and the follower 36 form a torque to thrust mechanism. The housing 34 has a spline 38 slidably engaging a spline 40 formed on a stationary housing portion 42. The housing 34 is secured to the rod 24. Therefore, the rod 24 and housing 34 move in unison.

The electric motor 28 is a conventional electric motor, which is controlled by an electronic control unit, not shown. The electronic control unit is preferably a conventional electronic control unit incorporating a programmable digital computer. These types of transmission control units are well known.

The electric motor 28 rotatably drives the shaft 30 and screw 32 such that the follower 36 will cause the housing 34 and the rod 24 to move linearly in the directions of Arrows A and B depending upon the direction of rotation of the shaft 30. As the shaft 30 is rotated, such that the housing 34 and rod 24 move in the direction of Arrow B, the end 26 of the band brake 12 will be caused to wrap tighter around the drum 16 resulting in application or engagement of the brake 10. When the electric motor 28 is rotated in a direction such that the housing 34 and rod 24 move in the direction of Arrow A, the frictional engagement between the band brake 12 and the drum 16 will be released and the drum 16 will be free to rotate. Thus, the brake 10 is applied and released through the rotation or direction of the electric motor 28. The friction in the screw 32 is such that the motor power can be discontinued once the band is applied or released with the apply or release being maintained.

In FIG. 2, an apply mechanism 14A incorporates the electric motor 28 and the shaft 30. The shaft 30 is drivingly connected with a spiral spring 44. The apply mechanism 14A also includes a housing 46, which has secured thereto a follower mechanism 48. The housing 46 is attached to the rod 24. As with the housing 34, the housing 46 includes a spline 50 that slidably engages a spline 52 formed on the housing 42. This prevents rotation of the housing 46. As the electric motor 28 rotatably drives the shaft 30, the follower 48 will move either up or down relative to the spiral spring 44 thereby causing the housing 46 and rod 24 to move linearly in the same direction.

An apply mechanism 14B is shown in FIG. 3. The apply mechanism 14B is quite similar to the apply mechanism 14A and includes an electric motor 28 and a shaft 30. The shaft 30 is connected with a housing 54, which has formed thereon a follower member 56. A spiral spring 58 is drivingly connected or otherwise secured with the rod 24. The spiral spring 58 is disposed internally of the housing 54 and includes an end tab or finger 60, which engages a spline 62 on the housing 42. The finger 60 and spline 62 prevent rotation of the spiral spring 58 while permitting linear movement of the spring.

The follower member 56 is inserted between adjacent coil members of the spiral spring 58. As the motor 28 and shaft 30 rotate the housing 54 and follower member 56, the spiral spring 58 is induced to move the rod 24 linearly thereby providing engagement and disengagement forces for the brake band, not shown in FIG. 3.

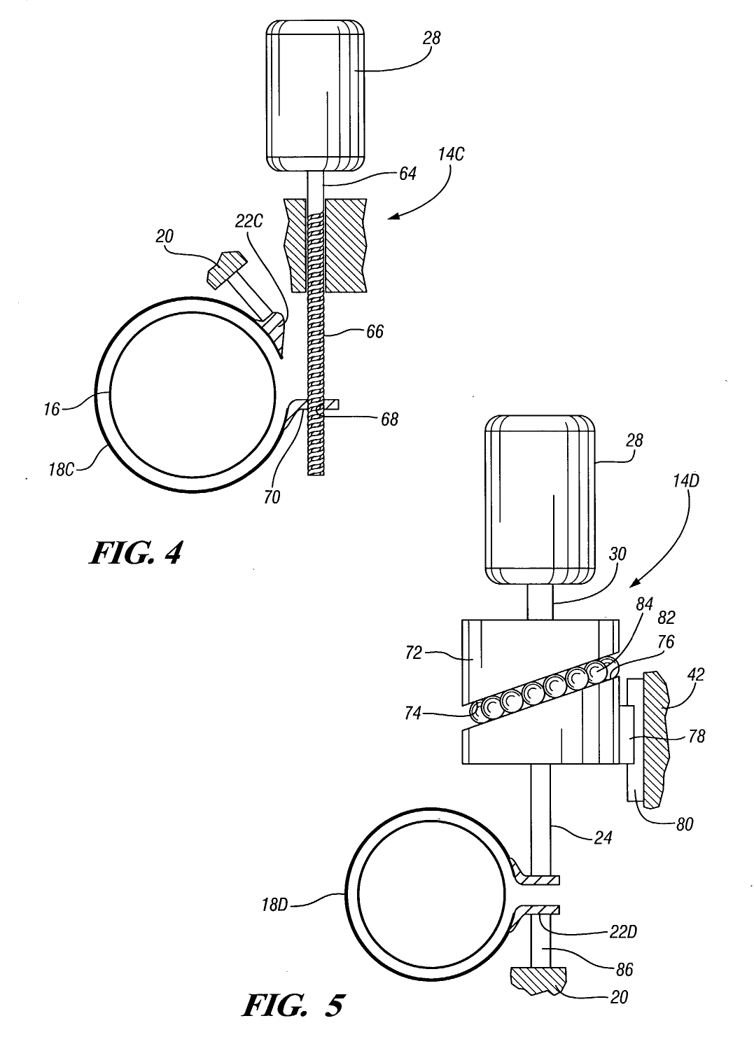

An apply mechanism 14C shown in FIG. 4 includes the electric motor 28, a shaft 64 having a spiral or helical surface 66 formed thereon. The helical surface 66 engages a helical receiver 68 formed on an end 70 of a brake band 18C. The brake band 18C is grounded at one end 22C to the housing 20 while the other end 70 engages the spiral portion 66 of the shaft 64. As the electric motor 28 is rotated, the helical receiver 68 will cause the end 70 of the brake band 18C to contract relative to the drum 16 or expand relative thereto, thereby providing for engagement or disengagement of the brake band 18C about the drum 16.

An apply mechanism 14D shown in FIG. 5 includes the electric motor 28 drivingly connected with the shaft 30. The shaft 30 is connected with a ramp or like member 72, which has a ramp 74 formed thereon. A second ramp member 76 is also included in the apply mechanism 14D. The ramp 76 includes a spline portion 78, which engages a spline 80 formed on the housing 42. The ramp member 76 has a ramp portion 82 separated from the ramp portion 74 by a plurality of spheres or rollers 84.

While the ramp mechanism is shown as having a single ramp 74 and a single ramp 82, it is well known that multiple ramps can be employed to provide for rotary-to-linear transfer to ramp members 72 and 76. As the ramp member 72 is rotated by the electric motor 28, the ramp member 76 will move linearly thereby causing the rod 24 to exert a downward force on the brake band 18D, which is supported at a reaction end 22D by a post or anchor 86 and the housing 20.

The brake apply mechanism of FIG. 5 differs from the other apply mechanisms in that the rod 24 pushes on the brake band to apply the system rather than pulling on the brake band as shown in the previous systems. However, those skilled in the art will appreciate that the mechanisms shown in FIGS. 1, 2, 3, and 4 can also be applied to push-type band apply mechanisms.

FIG. 6 describes a brake system utilizing two half bands. Half band systems are well known in the transmission art. These brake bands employ two half bands 88 and 90, as shown in FIGS. 6, 7, and 8. In these types of systems, the half bands must be actuated in substantially opposite directions in order to constrict about a brake drum 92 thereby engaging the brake bands 88 and 90 about the transmission drum 16.

In FIG. 6 a brake apply mechanism 14E is employed. The brake mechanism 14E may be constructed in accordance with any of the above-described systems. The brake apply mechanism 14E is not grounded at either end and is therefore free to cause linear motion to a pair of output rods 94 and 96. The output rod 94 operates on the half band 90 to cause engagement and disengagement with the brake drum 92. The output rod 96 has an element 98 slidably disposed in bushings 100 and 102. The rod 96 and element 98 operate on the half band 88 to cause contraction and expansion of the band 88 about the drum 92. The band 88 has an anchor or reaction portion 104, which is grounded to a transmission housing 106 and the band 90 has a reaction portion 108 grounded to the transmission housing 106.

Those skilled in the art will recognize that the band apply mechanism 14E needs two output members with the electric motor portion centrally located between them. The electric motor, of course, will have a grounded portion and output shafts directed from either end of the motor. These shafts will be connected with any of the previously described apply mechanisms.

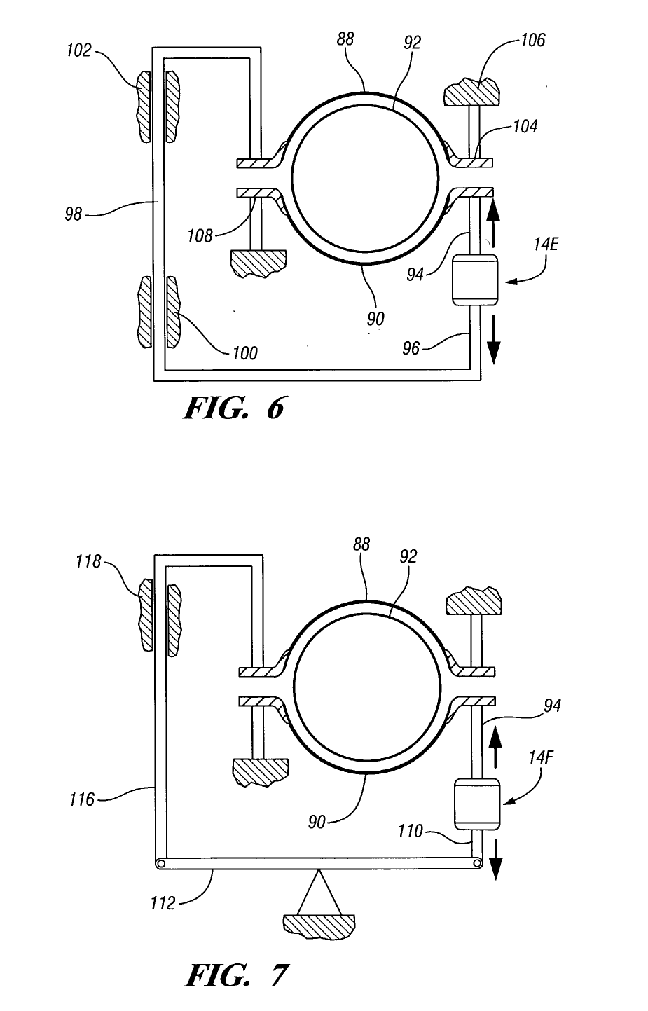

Shown in FIG. 7 is another half band system wherein an apply mechanism 14F provides a force on half band 90 through a rod 94 and also applies a force in the same direction as the forces on rod 94 through a rod 110. The rod 110 is connected with a lever 112, which has a fulcrum at 114. The lever 112 is connected with an apply rod 116, which is supported for linear movement in a bushing 118. The rod 116 provides a force on the band 88 to cause contraction and expansion thereof whenever application or release of the brake bands 88 and 90 about the drum 92 are desired.

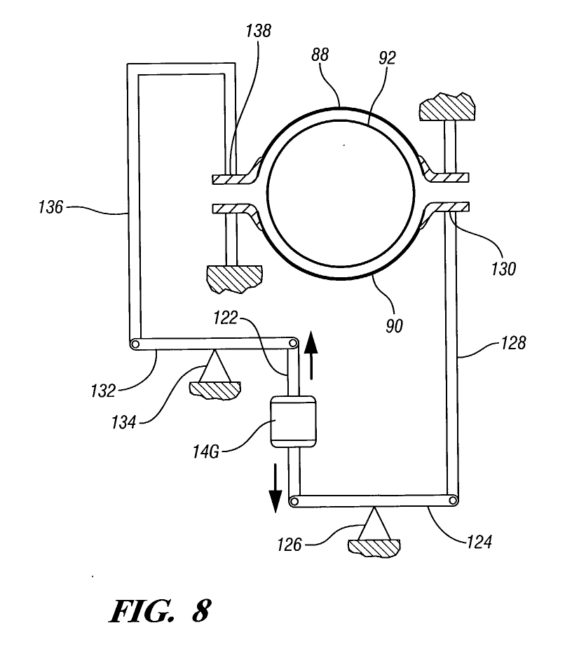

Another half band system having half bands 88 and 90 is shown in FIG. 8. With the band apply system shown in FIG. 8, a band apply mechanism 14G is situated to produce opposite movement on a pair of output rods 120 and 122. The rod 120 operates a lever 124, which has a fulcrum at 126. The lever 124 operates a rod 128, which is connected with the half band 90 at an end 130 to cause contraction and expansion of the half band 90 about the brake drum 92. The rod 122 operates on a lever 132, which has a fulcrum at 134. The lever 132 operates a rod 136, which engages an end 138 of the half band 88. The rod 136 is effective to cause expansion and contraction of the half band 88 in unison with the half band 90 to provide a braking function for the drum 92.

The band apply mechanism 14G can employ any of the apply mechanisms shown in FIGS. 1 through 5 to cause the desired movement of the rods 120 and 122. Note that the direction of linear motion of the rods 120 and 122 is determined by the direction of rotation of the drive motor and the directional sense of spiral in the helical screw portions shown for the above apply mechanisms or the angular direction of the ramps which are incorporated in apply mechanism 14B.

Obviously, many modifications and variations are possible in light of the above disclosure. Therefore, it should be understood that the invention is only to be limited by the scope of the appended claims.

1. A band brake apply mechanism comprising:
a drum member;
friction band means surrounding at least a portion of said drum and including at least one apply end and at least one reaction end;
an apply mechanism including an electric motor having a rotary member, an output member, and torque to thrust means disposed between said rotary member and said output member to convert the rotation of said rotary member to linear movement of said output member; and
said output member being operatively connected with said apply end to enforce engagement and disengagement of said friction band means and said drum member.

2. The band brake apply mechanism defined in claim 1 further comprising:
said torque thrust means includes a spiral spring member and a follower.

3. The band brake apply mechanism defined in claim 2 further wherein:
internal frictional forces between said spiral spring member and said follower are sufficient to maintain said friction band means in the engaged ore disengaged position after being positioned by said electric motor.

4. The band brake apply mechanism defined in claim 1 further comprising:
said torque thrust means includes a helical member and a follower with one of said helical member and said follower being rotatable with said rotary member and the other of said helical member and said follower being constrained for linear movement in response to rotation of said rotary member.

5. The band brake apply mechanism defined in claim 1 further comprising:
said torque to thrust means including a helical member rotatable with said rotary member and a follower member disposed for linear actuation in response to rotary actuation of said helical member.

6. A brake band apply mechanism comprising:
a drum member;
a pair of friction band means surrounding at least a portion of said drum and each band means including at least one apply end and at least one reaction end;
an apply mechanism including an electric motor having a rotary member, a pair of output members, and torque to thrust means disposed between said rotary member and said output members to convert the rotation of said rotary member to linear movement of said output member; and
said output members being operatively connected with said respective ones of said apply ends to enforce engagement and disengagement of said friction band means and said drum member.

7. The brake band apply mechanism defined in claim 6 further comprising:
said output member being moveable in substantially equal and opposite linear directions in response to rotary movement of said rotary member by said torque to thrust means.

8. The band brake apply mechanism defined in claim 6 further comprising:
said torque to thrust means including a pair of helical members rotatable with said rotary member and a pair of follower member disposed for linear actuation in response to rotary actuation of respective ones of said helical members.

9. The band brake apply mechanism defined in claim 8 further comprising:
said torque to thrust means having sufficient internal friction between said helical members and said follower members to maintain said friction band means in the engaged or disengaged position as set by said electric motor without continued input power from said electric motor.

10. The brake band apply mechanism defined in claim 6 further comprising:
said output member being moveable in the same linear direction in response to rotary movement of said rotary member by said torque to thrust means.
